(19) United States
(12) Patent Application Publication
(10) Pub. No.: US 2026/0138658 A1
(43) Pub. Date: May 21, 2026

(54) WHEELBARROW NET

(71) Applicant: Zbynek Sikora, Buford, GA (US)

(72) Inventor: Zbynek Sikora, Buford, GA (US)

(21) Appl. No.: 19/396,243

(22) Filed: Nov. 20, 2025

Related U.S. Application Data
(60) Provisional application No. 63/723,120, filed on Nov. 20, 2024.

(51) Int. Cl. B62B 1/22

(52) U.S. Cl. CPC B62B 1/22

(57) ABSTRACT

Implementations of a wheelbarrow net are provided. In some implementations, the wheelbarrow net comprises an elastic mesh portion formed from interconnected threads, an edge portion that bounds mesh portion; an attachment device configured to attach the wheelbarrow net to a wheelbarrow tray, and, in some implementations, a drawstring assembly configured to adjust the edge portion.

### CROSS REFERENCE TO RELATED APPLICATION

This application claims the benefit of U.S. Patent Application Ser. No. 63/723,120, which was filed on Nov. 20, 2024, and is incorporated herein by reference in its entirety.

### TECHNICAL FIELD

This disclosure relates to implementations of a wheelbarrow net.

### BACKGROUND

The tray of a wheelbarrow is used to carry a load (e.g., leaves, branches, etc.). To prevent the load from spilling, a net can be used to attempt to contain the load.

However, prior art nets are oversized and do not conform to the load. Furthermore, the nets are not attached to the wheelbarrow. Accordingly, prior wheelbarrow nets do not effectively contain the load in a wheelbarrow. Furthermore, the net is prone to being misplaced.

### BRIEF DESCRIPTION OF THE DRAWINGS

FIGS. 1-2 illustrates an example implementation of a wheelbarrow.

FIGS. 3 and 6 illustrate example implementations of a wheelbarrow net according to the present disclosure.

FIGS. 4-5 illustrates an example implementation of using a wheelbarrow net on a wheelbarrow.

### DETAILED DESCRIPTION

Implementations of a wheelbarrow net are provided. In some implementations, the wheelbarrow net is configured to be elastic and capable of stretching in one or more directions. In this way, the wheelbarrow net can conform to a load based on the size of the load.

In some implementations, the wheelbarrow net comprises a mesh portion. In some implementations, the mesh portion is formed from interconnected threads. The size and shape of the mesh portion may be any suitable size. The openings in the mesh portion may be any suitable size.

In some implementations the mesh portion is bound by an edge or border. In some implementations, the mesh portion is sized to extend over the opening of a tray of a wheelbarrow. In some implementations, the mesh portion is sized to extend over the opening of a tray of a wheelbarrow without being oversized.

In some implementations, the mesh portion is stretchy. In some implementations, the threads are stretchy. In some implementations, the threads are elastic. In some implementations, the threads are configured to elongate in response to an applied force and to return, or substantially return, to their original size when the force is removed. In some implementations, the threads are configured to elastically deform in response to an applied force and to return, or substantially return, to their original size when the force is removed. In some implementations, the threads are configured to elongate significantly (e.g., by about 20% to about 500% of their original length) and to return to at least about 90% to about 95% of their original length upon removal of the applied force. In some implementations, the threads comprise an elastomeric component (e.g., rubber, elastane, polyurethane) and/or an elastic construction (e.g., a braided or knitted configuration) that enables significant elongation in response to an applied force and recovery upon removal of the force. In some implementations, the elastic threads described herein are distinguishable from conventional non-elastic threads (e.g., cotton, nylon, or polyester threads) that may exhibit only minimal elongation under force and that do not substantially recover their original length once the force is removed.

In some implementations, the threads are made from spandex, elastane, rubber, or other suitable elastic material.

In some implementations, the edge or border of the wheelbarrow net is stretchy, for example, like a fitted sheet.

In some implementations, the edge or border of the wheelbarrow net is made from an elastic material.

In some implementations, at least a portion of the edge or border is adjustable using a drawstring.

In some implementations, when the wheelbarrow net is not in use, the wheelbarrow net contracts in size. In some implementations, when the wheelbarrow net is not in use, the mesh portion contracts in size.

In some implementations, when the wheelbarrow net is in use, the wheelbarrow net expands in size based on the size of the load. In some implementations, when the wheelbarrow net is in use, the mesh portion expands in size based on the size of the load.

In some implementations, the wheelbarrow net comprises an attachment device configured to attach the net to the wheelbarrow tray. In some implementations, the attachment device attaches to the outermost edge, lip, or rim of the wheelbarrow net. In some implementations, the attachment device is permanently (i.e., fixedly) attached to the wheelbarrow net.

In some implementations, the attachment device is configured to engage the outermost edge, lip, or rim of the wheelbarrow tray. In this way, the wheelbarrow net will stay co-located with the wheelbarrow when the wheelbarrow net or the wheelbarrow is not in use.

In some implementations, the attachment device is made from a sturdy yet flexible material. In some implementations, the attachment device is made from rubber, polyethylene, or silicone. In some implementations, the attachment device is made from any suitable material.

In some implementations, a method of using the wheelbarrow net comprises attaching the wheelbarrow net to a wheelbarrow tray using the attachment device and covering a load with the wheelbarrow net. In some implementations, the method comprises attaching the attachment device to the lip or edge of the wheelbarrow tray.

In some implementations, the method further comprises adjusting the edge or border of the wheelbarrow net. In some implementations, the method comprises adjusting the border of the wheelbarrow net using the drawstrings.

In some implementations, the method further comprises attaching the wheelbarrow net to a wheelbarrow tray using the attachment device when the wheelbarrow or wheelbarrow net is not in use.

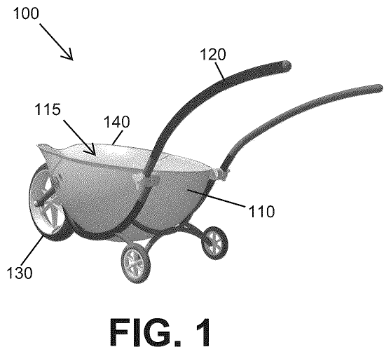

FIG. 1 illustrates an example implementation of a wheelbarrow 100. The wheelbarrow comprises a tray 110, handles 120, and wheels 130.

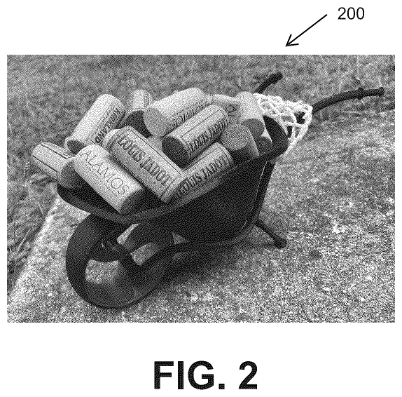

As shown in FIG. 1, the tray 110 is an open container configured to hold a load. FIG. 2 illustrates an example implementation of a wheelbarrow 200 having an open container holding a load. The tray 110 can be any suitable shape or size. The tray 110 can be made from any suitable material such as steel, aluminum, plastic, or any other suitable material.

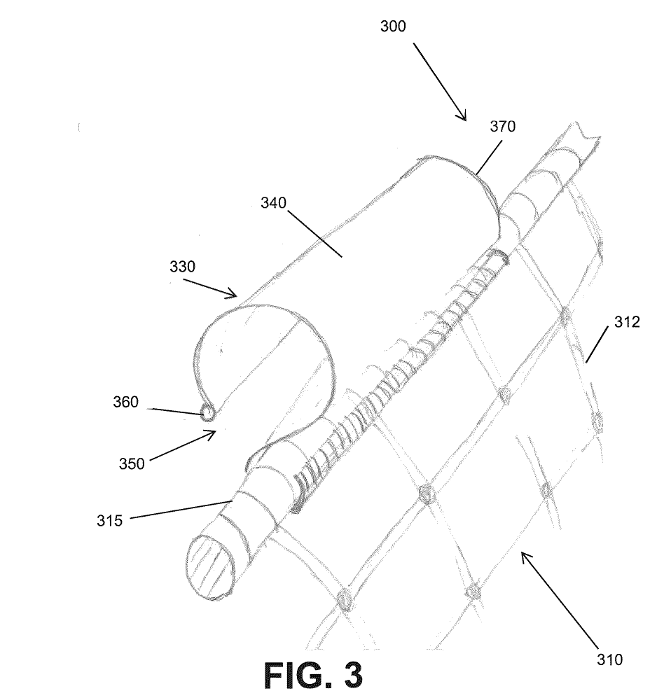

FIG. 3 illustrates an example implementation of a wheelbarrow net 300 according to the present disclosure.

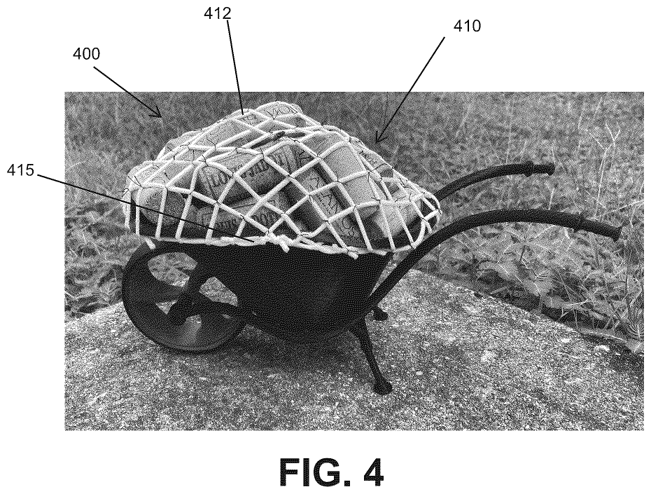

In some implementations, the wheelbarrow net 300 is configured to be elastic and capable of stretching in one or more directions. In this way, as shown in FIG. 4, the wheelbarrow net can conform to a load based on the size of the load.

In some implementations, the wheelbarrow net 300 comprises a mesh portion 310, 410 and an attachment device 330 configured to attach the wheelbarrow net 300 to the wheelbarrow tray 110. In some implementations, the attachment device 330 is permanently (i.e., fixedly) attached to the wheelbarrow net. In some implementations, the attachment device 330 is releasably attached to the wheelbarrow net.

In some implementations, the mesh portion 310, 410 is formed from interconnected threads 312, 412. The size and shape of the mesh portion 310, 410 may be any suitable size. The openings in the mesh portion 310, 410 may be any suitable size.

In some implementations the mesh portion 310, 410 is bounded by an edge or border 315, 415.

In some implementations, the mesh portion 310, 410 is stretchy. In some implementations, the threads are stretchy 312, 412. In some implementations the threads 312, 412 are elastic. In some implementations, the threads 312, 412 are configured to elongate in response to an applied force and to return, or substantially return, to their original size when the force is removed. In some implementations, the threads 312, 412 are configured to elastically deform in response to an applied force and to return, or substantially return, to their original size when the force is removed. In some implementations, the threads 312, 412 are configured to elongate significantly (e.g., by about 20% to about 500% of their original length) and to return to at least about 90% to about 95% of their original length upon removal of the applied force. In some implementations, the threads 312, 412 comprise an elastomeric component (e.g., rubber, elastane, polyurethane) and/or an elastic construction (e.g., a braided or knitted configuration) that enables significant elongation in response to an applied force and recovery upon removal of the force. In some implementations, the elastic threads described herein are distinguishable from conventional non-elastic threads (e.g., cotton, nylon, or polyester threads) that may exhibit only minimal elongation under force and that do not substantially recover their original length once the force is removed.

In some implementations, the threads 312, 412 are made from spandex, elastane, rubber, or other suitable elastic material.

In some implementations, the edge or border 315, 415 of the wheelbarrow net is stretchy, for example, like a fitted sheet. In some implementations, the edge or border 315, 415 of the wheelbarrow net is made from an elastic material. In some implementations, the edge or border 315, 415 of the wheelbarrow net is not stretchy.

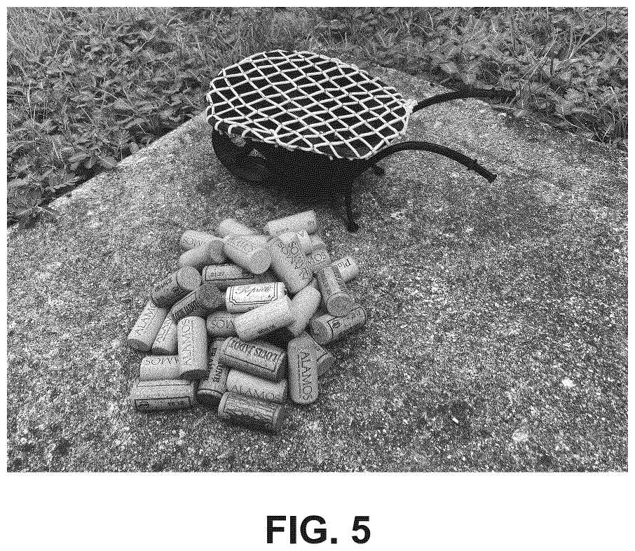

In some implementations, when placed on an empty tray 110, as shown in FIG. 5, the mesh portion 310, 410 is configured to cover the opening 115 of the tray 110. In some implementations, when placed on an empty tray 110, the mesh portion 310, 410 is configured to extends fully over the opening 115 without being materially oversized (i.e., without significant sagging or excessive overhang that would diminish its effectiveness in securing a load that does not extend above or beyond the confines of the tray 110). In some implementations, when a load placed in the tray 110 extends above or beyond the confines of the tray 110, the mesh portion 310, 410 expands to accommodate the load. In some implementations, when the wheelbarrow net 300 is removed from around the tray 110, the mesh portion 310, 410 contracts to a size smaller than the opening 115 of the tray 110.

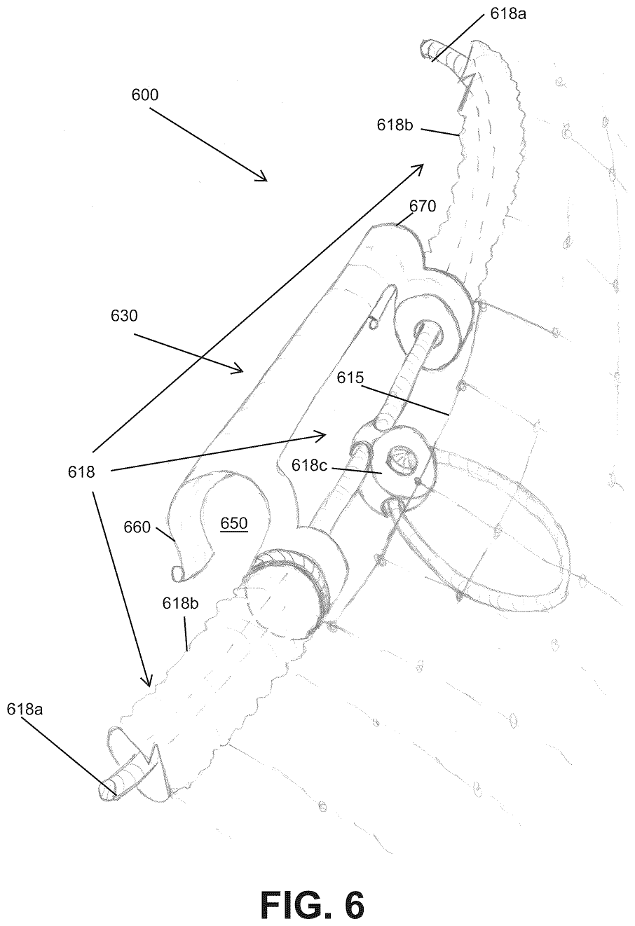

FIG. 6 illustrates another example implementation of a wheelbarrow net 600 according to the present disclosure. In some implementations, at least a portion of the edge or border is adjustable using a drawstring mechanism 618. In some implementations, the drawstring mechanism 618 comprises a drawstring 618a, a channel (or casing) 618b through which the drawstring 618a runs. In some implementations, the channel 618b is tunnel-like and is sewn onto the edge or border of the edge or border 315, 415, 615 of the wheelbarrow net. The channel 618b guides the drawstring 618a along the desired path. In some implementations, the channel 618b is a folded-over piece of fabric or material, sewn along its edges to create a passage for the drawstring.

In some implementations, the drawstring mechanism 618 comprises a lock, toggle, or cord stop 618c configured to allow the drawstring to be secured in place without tying it. The drawstring can be secured by pressing a button or squeezing a toggle.

In some implementations, when the wheelbarrow net is not in use, the mesh portion 310, 410 contracts in size. In some implementations, when the wheelbarrow net is in use, the mesh portion 310, 410 expands in size based on the size of the load.

As shown in FIG. 3, in some implementations, the attachment device 330 has the form of an elongated hollow tube 340 with a slit 350 extending lengthwise from one end 360 to an opposite end 370. The slit 350 is sized to receive a portion of the outermost edge 140, lip, or rim of the tray 110 of the wheelbarrow to secure the attachment device 330 to the tray 110. In this way, the wheelbarrow net will stay co-located with the wheelbarrow when the wheelbarrow net or the wheelbarrow is not in use.

In some implementations, the elongated tube 340 is 18 inches long or thereabout. In some implementations, the elongated tube 340 is longer than 18 inches. In some implementations, the elongated tube 340 is shorter than 18 inches.

In some implementations, the elongated tube 340 is made from a sturdy, yet flexible material. In some implementations, the elongated tube 340 is made from rubber, polyethylene, or silicone. In some implementations, the elongated tube 340 is made from a durable rubber material of the type commonly used in tires, such as a natural or synthetic rubber compound (e.g., styrene-butadiene rubber (SBR), butadiene rubber (BR), or a vulcanized rubber formulation), or another material with similar durability and flexibility characteristics. In some implementations, the elongated tube 340 is made from any suitable material.

As shown FIG. 6, in some implementations, the attachment device 630 is elongated with an opening 650 extending lengthwise from one end 660 to an opposite end 670. The opening 650 is configured to snap around a portion of the outermost edge 140, lip, or rim of the tray 110 of the wheelbarrow to secure the attachment device 630 to the tray 110.

In some implementations, the attachment device 630 is integral to the drawstring mechanism 618. In some implementations, the drawstring mechanism 618 is attached to the edge or border of the mesh portion 610 and the attachment device 630 is attached to drawstring mechanism 618. For example, in some implementations, attachment device 630 includes openings on opposite ends of the attachment device to receive the drawstring 618a.

In some implementations, an attachment device and drawstring mechanism are separate mechanisms.

In some implementations, a method of using the wheelbarrow net 300, 600 comprises attaching the wheelbarrow net to a wheelbarrow tray using the attachment device 330, 630 and covering a load with the wheelbarrow net. In some implementations, the method comprises attaching the attachment device to the outermost edge 140, lip, or rim of the wheelbarrow tray 110. In some implementations, the method comprises receiving a portion of the outermost edge 140, lip, or rim of the wheelbarrow tray 110 through the slit 350, 650 of the attachment device to attach the wheelbarrow net to a wheelbarrow tray.

In some implementations, the method further comprises adjusting the edge or border of the wheelbarrow net. In some implementations, the method comprises adjusting the edge or border of the wheelbarrow net using the drawstrings 618.

In some implementations, the method further comprises attaching the wheelbarrow net to a wheelbarrow tray using the attachment device 330, 630 when the wheelbarrow or wheelbarrow net is not in use.

The figures, including photographs and drawings, comprised herewith may represent one or more implementations of a wheelbarrow net.

Details shown in the figures, such as dimensions, descriptions, etc., are exemplary, and there may be implementations of other suitable details according to the present disclosure.

Reference throughout this specification to “an embodiment” or “implementation” or words of similar import means that a particular described feature, structure, or characteristic is included in at least one embodiment or implementation of the present disclosure. Thus, the phrase “in an embodiment”, “in some implementations”, or a phrase of similar import in various places throughout this specification does not necessarily refer to the same embodiment or implementation.

Many modifications and other embodiments of the present disclosure set forth herein will come to mind to one skilled in the art to which these disclosures pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the disclosure. One skilled in the relevant art will recognize, however, that embodiments of the present disclosure can be practiced without one or more of the specific details, or with other methods, components, materials, etc. In other instances, well-known structures, materials, or operations may not be shown or described in detail.

While operations may be depicted in the drawings or described in the specification in a particular order, this should not be understood as requiring that such operations be performed in the particular order shown or described or in sequential order, or that all illustrated or described operations be performed, to achieve desirable results.

1. A wheelbarrow net comprising:
a mesh portion formed from interconnected threads wherein the mesh portion is elastic;
an edge portion wherein the edge portion bounds the mesh portion and is elastic;
an attachment device configured to attach the wheelbarrow net to a wheelbarrow tray wherein the attachment device is configured to engage the outermost edge of the wheelbarrow tray; and
a drawstring configured to adjust the edge portion.

2. The wheelbarrow net of claim 1 wherein the attachment device comprises an elongated hollow tube with a slit extending lengthwise from one end of the tube to an opposite end of the tube wherein the slit is sized to receive a portion of the outermost edge of the wheelbarrow tray to secure the attachment device to a wheelbarrow tray.

3. A method of using the wheelbarrow net of claim 1 comprising:
attaching the wheelbarrow net to a wheelbarrow tray using the attachment device; and
covering a load with the wheelbarrow net.

4. The method of claim 3 wherein attaching the wheelbarrow net to a wheelbarrow tray using the attachment device comprises receiving a portion of the outermost edge of a wheelbarrow tray through the slit of the attachment device.

5. The method of claim 3 further comprising adjusting the edge portion using the drawstring.

6. A wheelbarrow comprising
a tray; and
a wheelbarrow net attached to the outermost edge of the wheelbarrow tray,
wherein the wheelbarrow net comprises:
a mesh portion formed from interconnected threads wherein the mesh portion is elastic;
an edge portion wherein the edge portion bounds the mesh portion; and
an attachment device configured to attach the wheelbarrow net to a wheelbarrow tray wherein the attachment device is configured to engage the outermost edge of the wheelbarrow tray.

7. The wheelbarrow of claim 6 wherein the edge portion is elastic and comprises a drawstring assembly.

8. The wheelbarrow of claim 6 wherein the attachment device comprises an elongated hollow tube with a slit extending lengthwise from one end of the tube to an opposite end of the tube wherein the slit is sized to receive a portion of the outermost edge of the wheelbarrow tray to secure the attachment device to a wheelbarrow.

9. A method of using the wheelbarrow of claim 6 comprising:
attaching the wheelbarrow net to the wheelbarrow tray using the attachment device; and
covering a load with the wheelbarrow net.

10. The method of claim 9 wherein attaching the wheelbarrow net to a wheelbarrow tray using the attachment device comprises receiving a portion of the outermost edge of a wheelbarrow tray through the slit of the attachment device.

11. The method of claim 9 further comprising adjusting the edge portion using the drawstring.

12. A wheelbarrow net comprising:
a mesh portion formed from interconnected threads;
an edge portion wherein the edge portion bounds the mesh portion; and
an attachment device configured to attach the wheelbarrow net to a wheelbarrow tray wherein the attachment device is configured to engage the outermost edge of a wheelbarrow tray.

13. The wheelbarrow net of claim 12 further comprising a drawstring configured to adjust the edge portion.

14. The wheelbarrow net of claim 12 wherein the attachment device comprises an elongated hollow tube with a slit extending lengthwise from one end of the tube to an opposite end of the tube wherein the slit is sized to receive a portion of the outermost edge of the wheelbarrow tray to secure the attachment device to a wheelbarrow tray.

15. A method of using the wheelbarrow net of claim 12 comprising:
attaching the wheelbarrow net to a wheelbarrow tray using the attachment device.

16. The method of claim 15 further comprising covering a load with the wheelbarrow net.

17. The method of claim 14 wherein attaching the wheelbarrow net to a wheelbarrow tray using the attachment device comprises receiving a portion of the outermost edge of a wheelbarrow tray through the slit of the attachment device.

18. The method of claim 14 further comprising adjusting the edge portion using the drawstring.
